(19) United States
(12) Patent Application Publication
(10) Pub. No.: US 2002/0067407 A1
(43) Pub. Date: Jun. 6, 2002

(54) Universal docking station for imaging systems in a dental operatory

(76) Inventor: David H. Cooper, Carlsbad, CA (US)

Correspondence Address: MCNEES, WALLACE & NURICK, 100 PINE STREET, P.O. BOX 1166, HARRISBURG, PA, 17108-1166, US

(21) Appl. No.: 09/828,079

(22) Filed: Apr. 6, 2001

Related U.S. Application Data
(60) Provisional application No. 60/195,010, filed on Apr. 6, 2000.

(51) Int. Cl. H04N 7/18

(52) U.S. Cl. 348/66; 348/73; 348/74; 348/75

(57) ABSTRACT

A universal docking station is provided for a dental operatory to manage a plurality of imaging subsystems. The digitally processed imaging subsystems include video cameras for intra- or extra-oral imaging, video surgical microscopes, x-ray film scanners, digital x-rays and any other type of imaging system that produces an S-video, composite video or digital video signal output. The universal docking station may provide each of the imaging subsystems with operating utilities, such as power and light, and instructions for controlling operation of the subsystem. The universal docking station receives outputs from each of the imaging subsystems for display, processing, recording and/or other uses. The universal docking system provides interfaces for selecting and operating various peripheral systems such as monitors, computers, multiplexers or printers and for digital control and manipulation of images from the imaging subsystems.

### CROSS-REFERENCE TO RELATED APPLICATIONS

This application claims the benefit of U.S. Provisional Patent Application No. 60/195,010 filed on Apr. 6, 2000.

### BACKGROUND OF THE INVENTION

The present invention is related generally to the field of docking stations for video imaging systems. Specifically, the present invention is related to a single, universal docking station to be used with all video imaging systems used in a dental operatory.

Today's dental operatory includes many dental imaging systems designed to assist the dentist, each system of which requires various utilities such as power and light for operation. Each of these dental imaging systems also generates an output that is directed to a monitor, recording device or the like for review and assessment by the clinician. Each of the dental imaging systems further requires the entry or inputting of instructions for operation, interaction and control of the dental imaging system. The delivery of utilities and control instructions to the dental imaging system and the receipt of output from the dental imaging system is accomplished with a docking station configured for use with that particular dental imaging system. The docking station is then typically linked or connected to a computer, monitor, etc. to provide the control instructions to the docking station for the dental imaging system and/or to process or display the output received by the docking station from the dental imaging system for the clinician to review.

Thus, a dental operatory that typically includes a video camera for intra- and extra-oral imaging of dental anatomy, a digital x-ray system, a video surgical microscope, and other systems and subsystems will require a equivalent number of docking stations for use with those systems in the dental operatory. The use of multiple docking stations in the dental operatory can be difficult to configure for coordinated operation with a single computer without having any conflicts, can occupy a significant amount of area in the dental operatory and can pose a potential health or safety risk.

Therefore, what is needed is to have the utilities and operating functions of as many of these dental imaging systems functioning together with as few peripheral systems as possible. Thus, it is an object of the present invention to provide a universal docking station that has the capability of managing all of the dental operatory subsystems, providing them with utilities and appropriate control and reporting services.

### SUMMARY OF THE INVENTION

A universal docking station is provided for a dental operatory to manage a plurality of imaging subsystems. The universal docking station may provide each of the subsystems with operating utilities, such as power and light, and instructions for controlling operation of the subsystem. The universal docking station receives outputs from each of the subsystems for display, processing, recording and/or other uses. The universal docking station also provides interfaces for selecting and operating various peripheral systems such as monitors, computers, multiplexers or printers and for digital control and manipulation of images from the imaging subsystems.

The dental imaging subsystems interfacing with the universal docking station can include video cameras for intra- or extra-oral imaging, video surgical microscopes, x-ray film scanners, digital x-rays and any other imaging system that produces an S-video, composite video or digital video signal output.

One advantage of the present invention is that all the dental imaging systems used in a dental operatory can be operated and controlled from a single unit in the operatory.

Another advantage of the present invention is that it provides the clinician with a single compact interface for the various imaging devices he may need in the operatory.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

The present invention is described in greater detail below with reference to the following drawings:

FIG. 1 is a schematic view of the interaction of dental systems with the universal docking station (UDS) of the present invention;

FIG. 2 is a front view of a wall mounted UDS with remote operating panel;

FIG. 3 is an enlarged schematic view of an operating membrane panel of the UDS; and

FIG. 4 is a bottom view of the wall mounted UDS of FIG. 2.

Whenever possible, the same reference numbers will be used throughout the figures to refer to the same parts.

### DESCRIPTION OF THE PREFERRED EMBODIMENTS

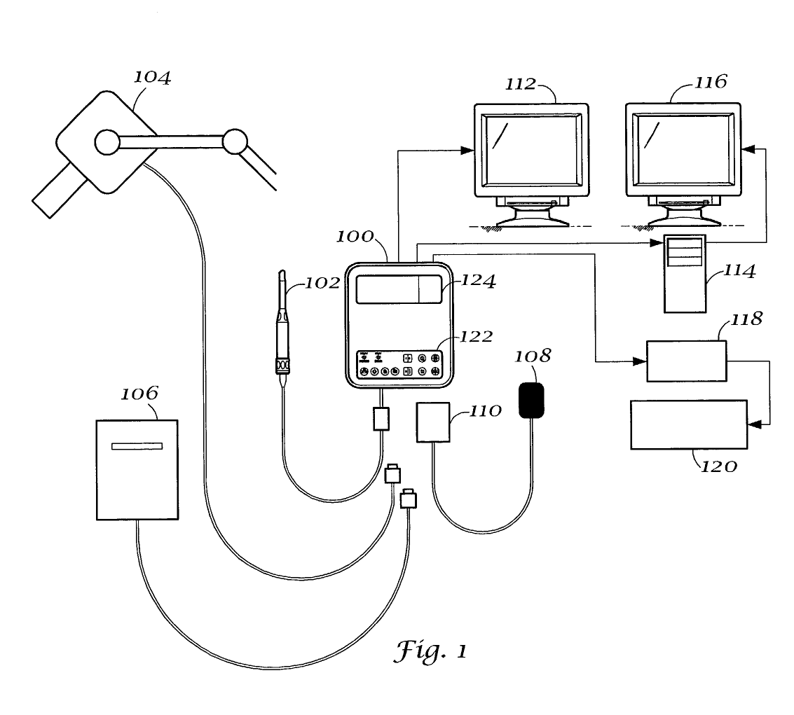

FIG. 1 illustrates schematically the interconnections of a universal docking station (UDS) 100 with dental imaging systems and other systems and devices located in a dental operatory. The UDS 100 enables the interconnection of several different instruments or systems at a single location. Some of the different dental imaging systems that can be docked at the UDS 100 include:

an intra-oral camera 102;

a video surgical microscope 104;

an x-ray film scanner 106;

various video equipment, such as a VCR, video camera, camcorder, DVD, etc. (not shown); and

a digital x-ray sensor 108 and interface module 110.

The UDS 100 functions as an interface between the dental imaging systems described above and other systems or devices located inside or outside of the operatory that are used by the clincian in conjunction with the dental imaging systems. These other systems and devices used by the clinician are also connected to the UDS 100 and can include:

a video monitor 112;

a computer 114 with computer monitor 116; and

a multiplexer 118 and printer 120.

In addition, the UDS 100 includes an integrated printer and multiplexer control system, which avoids the need for additional interface components for the multiplexer 118 and printer 120. The UDS 100 also includes the processors, circuits and programming for a high performance freeze frame utility, which enables the UDS 100 to perform a new level of image capture and manipulation.

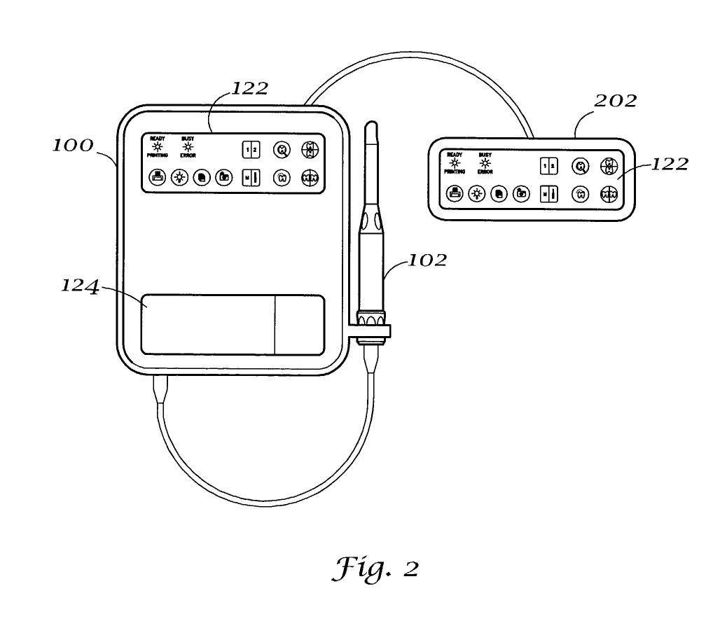

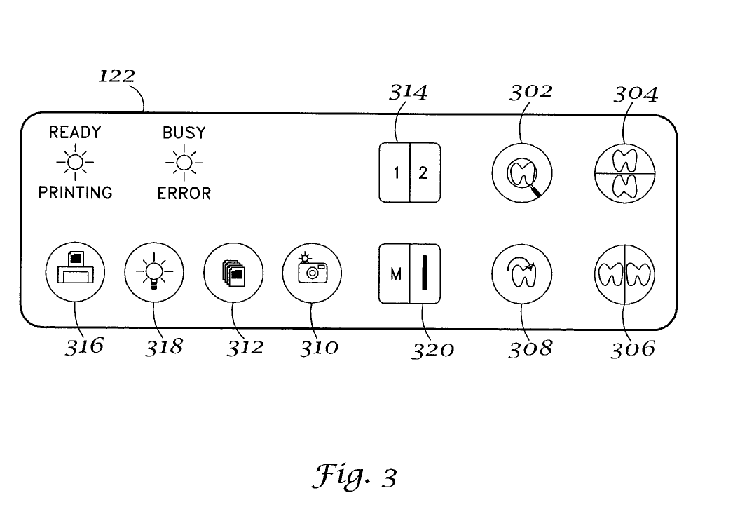

The UDS 100 can be mounted on a table top in the operatory or on a wall in the operatory (see FIG. 2). The connections for the dental imaging systems and the other systems and devices are preferably located on the sides of the UDS 100, but can be located anywhere on the UDS 100. A top cover can extend over the areas of the UDS 100 that receives the various power, signal and control connections and can be effective in hiding the wiring when the UDS 100 is wall-mounted. In addition, the UDS 100, includes a control panel 122 for using and controlling the UDS 100 and the freeze frame utility. FIG. 3 shows a preferred membrane control panel 122 for operating the various subsystems and performing the functions discussed below.

When the UDS 100 is mounted on a countertop, the membrane panel 122 is preferably located at the bottom front of the UDS 100 and a filler panel 124 is preferably located in the recess at the top rear of the UDS 100. In the wall-mount configuration of the UDS 100 as shown in FIG. 2, the membrane panel 122 is preferably located at the top of the UDS 100, which corresponds to the top rear of the UDS 100 in the countertop configuration, and the filler panel 124 is preferably located at the bottom of the UDS 100, which corresponds to the bottom front of the UDS 100 in the countertop configuration. The reversal of the placement of the membrane panel 122 and the filler panel 124 in the wall-mounted configuration from the countertop configuration is because a bottom mounted membrane panel would be inconvenient for the clinician.

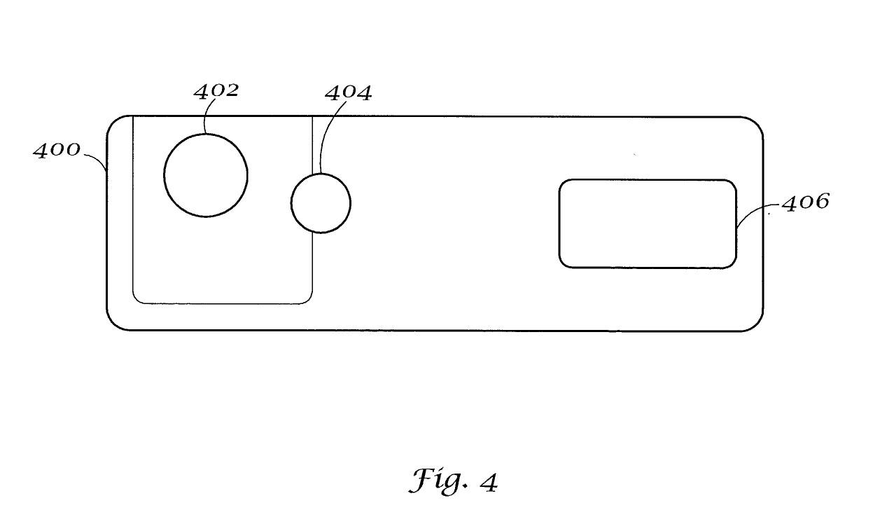

FIG. 4 illustrates a connection panel 400 for the UDS 100, which is located on a front side of the UDS 100 in the countertop configuration or on the bottom side of the UDS 100 in the wall-mounted configuration. The connection panel 400 preferably includes:

a modified Lemo receptacle 402 to receive a camera cable connector;

an additional S-video input connector 404 for connection to other video accessories; and

a port 406 with spring loaded flap to receive a digital x-ray plug-in module.

The intra-oral camera 102 can be plugged into the UDS 100 via a modified Lemo connector at the modified Lemo receptacle 402 located at the front of the UDS 100 in the countertop configuration or at the bottom of the UDS 100 in the wall-mount configuration.

The camera cable connecting the inter-oral camera 102 and the UDS 100 includes a light guide that terminates in a stainless steel ferrule, which ferrule replaces the standard coaxial connector in the center of a typical Lemo connector. In addition, the remaining conductors in the camera cable are terminated to the ten (10) surrounding pins in the Lemo connector. The coaxial socket is removed from a standard Lemo receptacle, which permits the light guide ferrule to pass through and to be inserted into a light source when the modified Lemo connector is plugged into the modified Lemo receptacle 402.

The S-video input connector or receptacle 404 is preferably located adjacent to the modified Lemo receptacle 402 on the connection panel 400. The S-video receptacle 404 can receive any standard NTSC, PAL or any other recognized standard video signal, such as from a VCR, video camera, camcorder, DVD, or other various types of video equipment.

The docking port 406 at the front of the UDS 100 accepts the module 110 connected to the digital x-ray sensor 108. The digital x-ray port 406 provides power to the module 110 and receives processed sensor signals. The digital x-ray port 406 is directly connected to a universal serial bus (USB) port located on the UDS 100 to transmit the received processed sensor signals to the computer 114. The digital x-ray port 406 can provide the power to the module 110 from the computer 114 via the USB connection or from a power supply in the UDS 100, if the module 110 power requirement is low. Otherwise, a receptacle for external power is provided on the UDS 100 and is connected to the digital x-ray port 406. The digital x-ray port 406 can be compatible with any wired digital x-ray system because the digital x-ray port 406 is essentially passive, merely providing a docking facility and a signal throughput to the computer 114.

An additional connection panel for the UDS 100, which is located on the rear side of the UDS 100 in the countertop configuration or on the top side of the UDS 100 in the wall-mounted configuration, preferably can include:

(2) S-video output connections;

an encoded video output connection;

a printer or multiplexer control connection;

one or more universal serial bus (USB) connections;

a connection for a foot switch;

a power connection for the digital x-ray system;

a parallel data output connection from the digital x-ray system;

a connection for a remote control panel; and

an AC receptacle and fuses.

In another embodiment of the present invention, the UDS 100 can be linked or connected to the dental imaging systems and the other systems and devices by wireless communication. The UDS 100 and the dental imaging systems and the other systems and devices preferably have infrared modules or RF modules for the transmission and receipt of signals and information wirelessly. For example, the UDS 100 can transmit control signals wirelessly to the video surgical microscope 104 and can then receive video signals from the video surgical microscope 104 also by wireless communication. Similarly, the UDS 100 can wirelessly transmit image data for display to the video monitor 112. In addition, the UDS 100 and the dental imaging systems and the other systems and devices can also have analog to digital or digital to analog converters as required for the wireless transmission.

A remote control panel 202 (see FIG. 2) may be provided to enable control of the UDS 100 from a convenient remote location. The remote control panel 202 includes a duplicate of the top cover membrane panel 122 on the UDS 100. The connection to the remote panel 202 from the UDS 100 can be by hard-wiring, by radio frequency transmission, or by infrared control.

The x-ray film scanner 106 enables a standard bite wing film image to be converted to a video signal and displayed on the video monitor 112, or digitized via a computer frame grabber board. An x-ray film is inserted into the film scanner 106 and is backlit by a suitable incandescent or fluorescent lamp. A lens focuses the backlit image onto a black and white sensor assembly, consisting of a sensor mounted on a camera control unit (CCU) board. The film scanner 106 may be powered by a built-in, or external power supply, or from the UDS 100. The output video signal from the film scanner 106 is preferably connected to the S-video connector 404 on the UDS 100, but can be connected at any connection panel of the UDS 100.

Previously, surgical microscopes used in dentistry were optical instruments, which enabled the Dentist to view a highly magnified image of the patient's oral cavity through its eyepiece. However, the video surgical microscope (VSM) 104, shown schematically in FIG. 1, provides a highly magnified image of the oral cavity to be displayed on a video monitor 114, which can be viewed by the clinician in a more comfortable manner, instead of being hunched over an optical microscope. The VSM 104 is mounted on an articulating arm and suitably positioned to view the desired area of the patient's mouth. A telephoto lens applies a magnified image to a sensor, which is connected to a CCU board. The VSM 104 may be powered by a built-in or external power supply, or from the UDS 100. The output video signal from the VSM 104 is preferably connected to the S-video connector 404 on the UDS 100, but can be connected at any connection panel of the UDS 100.

The freeze frame utility includes a freeze frame board and a piggyback isolation board. The freeze frame utility enables up to four (4) full frame images to be captured, either by means of a footswitch, or by a membrane control panel button, e.g. capture button 310 shown in FIG. 3. The captured images can be displayed individually, or in split-4 configuration on the video monitor 112 or on the computer monitor 116. The user can control the display of the captured images by selecting an appropriate button on the membrane control panel 122, e.g. image select button 312 shown in FIG. 3. The freeze frame utility also includes programming and circuitry such that the captured images can be flipped horizontally or vertically, rotated or electronically zoomed by means of appropriate buttons on the membrane control panel 122. On the membrane control panel 122 shown in FIG. 3, a user can electronically zoom-in on a captured image by selecting button 302, perform a vertical flip of the captured image by selecting button 304, perform a horizontal flip of the captured image by selecting button 306 and rotate the captured image by selecting button 308.

The freeze frame utility can accept at least two video inputs, one from the modified Lemo connector 402, which can be connected to the intra-oral camera cable, the other from the S-video connector 404 on the front panel, which can accept video from any standard S-video source. An appropriate button on the membrane control panel 122 controls the selection of the video source, e.g. source select button 314 shown in FIG. 3. In one embodiment of the present invention, source 1 can be from the modified Lemo connector 402 and source 2 can be from the S-video connector 404.

The printer 120 can be controlled from the membrane panel 122 by selecting an appropriate button for the “print” command, e.g. print button 316 shown in FIG. 3, which causes the printer to capture the displayed image and print it. The printer 120 can be connected to the UDS 100 through the multiplexer 118 as shown in FIG. 1 or can be directly connected to the UDS 100. Lights on the membrane control panel 122 indicate the printer status, as follows:

| | |
|---|---|
| Green | Printer ready |
| Flashing green | Printing in process |
| Orange | Printer busy |
| Flashing orange | Printer fault |

A two-position footswitch protocol enables the capture, display and printer control functions of the UDS 100 to be accomplished from a remote footswitch. The protocol also enables the captured image to be replaced and avoids the need to manually operate the membrane panel controls, which prevents a potential cross contamination problem.

The membrane control panel 122, also has an appropriate button for a user to control a light source in the UDS 100, e.g. light button 318 shown in FIG. 3. The light source in the UDS 100 can be used to provide light to the various dental systems connected to the UDS 100. The UDS 100 can also include a memory for storing a number of captured images. The user can retrieve the captured images from memory and print and display the images as described above. The user can designate where the image is supplied from, i.e. either from the memory in the UDS 100 or from a connected video source, by selecting an appropriate button on the membrane control panel 122, e.g. button 320 shown in FIG. 3.

In another embodiment of the present invention, a dental office can have a plurality of operatories, with each operatory having its own universal docking station 100. The plurality of UDSs 100 can be connected and configured to supply information to a central recording system, which is remotely located from said operatories. The central recording system can include a computer(s) and/or a printer(s). Additionally, the central recording system can include one or more analog or digital storage devices. The storage devices can include a floppy disk, a hard disk video image recorder, a flash memory card recorder, a CD-ROM recorder, or other similar type of storage device. To manage and conduct operation with the central recording system, each of the universal docking stations 100 is connected to a multiplexer 118, which receives the video signals and control information from each docking station 100. A print command from a particular UDS 100 causes the multiplexer 118 to select the video signal from that docking station 100 and route it to the printer 120. This is followed by a command from the multiplexer 118, which causes the printer 120 to capture and print the selected image.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A digitally processed imaging system, comprising:
a universal docking station having a plurality of connection points; and
a plurality of imaging systems connected to said universal docking station at said plurality of connection points, wherein each imaging system receives operating utilities and control instructions from said universal docking station and transmits video output signals to said universal docking station for display and further processing.

2. The digitally processed imaging system of claim 1, wherein at least one imaging system of said plurality of imaging systems provides an S-video output signal to said universal docking station at a corresponding connection point.

3. The digitally processed imaging system of claim 1, wherein at least one imaging system of said plurality of imaging systems provides a composite video output signal to said universal docking station at a corresponding connection point.

4. The digitally processed imaging system of claim 1, wherein at least one imaging system of said plurality of imaging systems provides a digital video output signal to said universal docking station at a corresponding connection point.

5. The digitally processed imaging system of claim 1, wherein at least one imaging system of said plurality of imaging systems comprises at least one of:
(a) a video camera for intra- or extra-oral imaging;
(b) a video surgical microscope;
(c) an x-ray film scanner; or
(d) a digital x-ray sensor and interface module.

6. The digitally processed imaging system of claim 1, wherein at least one imaging system of said plurality of imaging systems produces a video input signal.

7. The digitally processed imaging system of claim 6, wherein said at least one imaging system of said plurality of imaging systems producing a video input signal comprises a video camera.

8. The digitally processed imaging system of claim 1, wherein at least one imaging system of said plurality of imaging systems comprises a wireless transmission interface.

9. The digitally processed imaging system of claim 8, wherein said wireless transmission interface is an infrared module.

10. The digitally processed imaging system of claim 8, wherein said wireless transmission interfaces is a RF module.

11. The digitally processed imaging system of claim 1, wherein at least one imaging system of said plurality of imaging systems comprises a digital to analog converter and a transmission module.

12. The digitally processed imaging system of claim 1, further comprising at least one of a monitor, computer, computer monitor, multiplexer and printer connected to said universal docking station to receive output signals from said universal docking station corresponding to a video output signal from one of said plurality of imaging systems.

13. The digitally processed imaging system of claim 1, wherein said universal docking station comprises an image processing utility.

14. The digitally processed imaging system of claim 13, wherein said image processing utility comprises:
means for combining multiple images for subsequent display, printing or storage;
means for horizontally flipping an image;
means for vertically flipping an image;
means for rotating an image; and
means for zooming on an image.

15. The digitally processed imaging system of claim 13, wherein said image processing utility comprises means for capturing said video output signal from said plurality of imaging systems.

16. The digitally processed imaging system of claim 1, wherein said universal docking station comprises a control panel for a user to select operations to be performed by the universal docking station.

17. The digitally processed imaging system of claim 16, further comprises a remote device, said remote device being located at a distance from said universal docking station and said remote device being configured to control said universal docking station.

18. The digitally processed imaging system of claim 17, wherein said remote device is a footswitch.

19. The digitally processed imaging system of claim 17, wherein said remote device is a remote operation panel, and said remote operation panel comprises a control panel.

20. The digitally processed imaging system of claim 19, wherein said remote operation panel is connected to said universal docking station by a cable.

21. The digitally processed imaging system of claim 19, wherein said remote operation panel is connected to said universal docking station by a wireless connection.

22. The digitally processed imaging system of claim 21, wherein said wireless connection comprises one of an infrared transmission and an RF transmission.

23. A digitally processed imaging system, comprising:
(a) a universal docking station for a plurality of imaging subsystems, providing each subsystem with operating utilities and control instructions and receiving output from each of said subsystem for display and further processing;
(b) a plurality of operatories, each comprising a universal docking station; and
(c) a central recording system, remotely located from said operatories, wherein each of said universal docking stations comprises a multiplexer component for managing and conducting operation of said central recording system.

24. The digitally processed imaging system of claim 13, wherein said recording system comprises one or more printers.

25. The digitally processed imaging system of claim 13, wherein said recording system comprises one or more computers.

26. The digitally processed imaging system of claim 13, wherein said recording system comprises one or more storage devices.

27. The digitally processed imaging system of claim 16 wherein said storage device comprises one of a floppy disk, a hard disk video image recorder, and a flash memory card recorder.

28. A digitally processed imaging system, comprising:
a universal docking station having a plurality of interfaces; and
a plurality of imaging systems connected to said universal docking station at said plurality of interfaces, wherein each imaging system transmits video output signals to said universal docking station for display and further processing at a corresponding interface.

29. The digitally processed imaging system of claim 28 wherein each imaging system receives at least one of control signals, power and light from said universal docking station at a corresponding interface.

30. The digitally processed imaging system of claim 28, wherein at least one imaging system of said plurality of imaging systems provides an S-video output signal to said universal docking station at a corresponding interface.

31. The digitally processed imaging system of claim 28, wherein at least one imaging system of said plurality of imaging systems provides a composite video output signal to said universal docking station at a corresponding interface.

32. The digitally processed imaging system of claim 28, wherein at least one imaging system of said plurality of imaging systems provides a digital video output signal to said universal docking station at a corresponding interface.

33. The digitally processed imaging system of claim 28, wherein at least one imaging system of said plurality of imaging systems comprises at least one of:
(a) a video camera for intra- or extra-oral imaging;
(b) a video surgical microscope;
(c) an x-ray film scanner; or
(d) a digital x-ray sensor and interface module.

34. The digitally processed imaging system of claim 28, wherein at least one imaging system of said plurality of imaging systems produces a video input signal.

35. The digitally processed imaging system of claim 34, wherein said at least one imaging system of said plurality of imaging systems producing a video input signal comprises a video camera.

36. The digitally processed imaging system of claim 29, wherein at least one imaging system of said plurality of imaging systems comprises a wireless transmission interface.

37. The digitally processed imaging system of claim 36, wherein said wireless transmission interface is an infrared module.

38. The digitally processed imaging system of claim 36, wherein said wireless transmission interfaces is a RF module.

39. The digitally processed imaging system of claim 28, wherein at least one imaging system of said plurality of imaging systems comprises an digital to analog converter and a transmission module.

40. The digitally processed imaging system of claim 28, further comprising at least one of a monitor, computer, computer monitor, multiplexer and printer connected to said universal docking station to receive output signals from said universal docking station corresponding to a video output signal from one of said plurality of imaging systems.

41. The digitally processed imaging system of claim 28, wherein said universal docking station comprises an image processing utility.

42. The digitally processed imaging system of claim 41, wherein said image processing utility comprises:
means for combining multiple images for subsequent display, printing or storage;
means for horizontally flipping an image;
means for vertically flipping an image;
means for rotating an image; and
means for zooming on an image.

43. The digitally processed imaging system of claim 41, wherein said image processing utility comprises means for capturing said video output signal from said plurality of imaging systems.

44. The digitally processed imaging system of claim 28, wherein said universal docking station comprises a control panel for a user to select operations to be performed by the universal docking station.

45. The digitally processed imaging system of claim 44, further comprises a remote device, said remote device being located at a distance from said universal docking station and said remote device being configured to control said universal docking station.

46. The digitally processed imaging system of claim 45, wherein said remote device is a footswitch.

47. The digitally processed imaging system of claim 45, wherein said remote device is a remote operation panel, and said remote operation panel comprises a control panel.

48. The digitally processed imaging system of claim 47, wherein said remote operation panel is connected to said universal docking station by a cable.

49. The digitally processed imaging system of claim 47, wherein said remote operation panel is connected to said universal docking station by a wireless connection.

50. The digitally processed imaging system of claim 49, wherein said wireless connection comprises one of an infrared transmission and an RF transmisstion.
